(19) United States
(12) Patent Application Publication
(10) Pub. No.: US 2021/0121839 A1
(43) Pub. Date: Apr. 29, 2021

(54) PADDLE FOR CONTAINER-ROTATING MIXING DEVICE

(71) Applicant: NIPPON SOSEY KOGYO CO., LTD., Nagoya-shi, Aichi (JP)

(72) Inventors: Norihiro MORIKAWA, Nagoya-shi, Aichi (JP); Yoshihito KATO, Nagoya-shi, Aichi (JP)

(21) Appl. No.: 16/961,008

(22) PCT Filed: Mar. 5, 2019
(86) PCT No.: PCT/JP2019/008520

§ 371 Date: Jul. 9, 2020

(30) Foreign Application Priority Data
Mar. 5, 2018 (JP) 2018-038730
Mar. 1, 2019 (JP) 2019-037676

(51) Int. Cl. B01F 9/12

(52) U.S. Cl. CPC B01F 9/12; B01F 2009/0061

(57) ABSTRACT

A paddle in a three-pronged fork-like shape with the middle part longer than the others cannot uniformly knead a highly viscous fluid.

A paddle includes an arm portion disposed outside a container and a paddle portion integrally formed on the distal end of the arm portion and disposed inside the container. The paddle portion includes a horizontal part, vertical parts protruding upward from both end portions of the horizontal part, and a coupling shaft portion protruding upward from the middle of the horizontal part to the arm portion. Providing an inwardly protruding portion on the upper end of the second vertical part makes it possible to mix a mixing object in an area corresponding to a non-fluid area by using the inwardly protruding portion.

### TECHNICAL FIELD

The present invention relates to a paddle for a container-rotating mixing device that mixes mixing objects in a container by rotating the container.

### BACKGROUND ART

Conventionally, as such a paddle for a container-rotating mixing device, there is available a paddle (see, for example, Patent Document 1) which is made of metal and as shown in FIG. 7, includes an arm portion b disposed outside a container a and a paddle portion c integrally formed with the distal end of the arm portion b and disposed inside the container a. The paddle portion c includes a horizontal part d, vertical parts e and e′ protruding upward from both end portions of the horizontal part d, and a coupling shaft portion f protruding upward from the middle of the horizontal part d to the arm portion b. The lower surface of the horizontal part d and the outer side surfaces of the vertical parts e and e′ are provided with rubber wipers g, h, and h′. The paddle portion c is accommodated in the container a installed on a turntable t of a mixing device m. The paddle portion c can knead a mixing object w in the container a by rotating the container a using the turntable t.

### CITATION LIST

### Patent Literature

Patent Literature 1: Japanese Published Unexamined Patent Application No. 2006-204980

### SUMMARY OF INVENTION

### Technical Problem

When the above conventional paddle in the three-pronged fork-like shape with the middle part longer than the others is used for a highly viscous fluid as the mixing object w, a ring-like area s (the area indicated by cross-hatching in FIG. 7) located further inward and upward than the upper ends of the vertical parts e and e′ does not flow. This poses various problems to be solved, such as the occurrence of a non-fluid area that disables uniform kneading of a highly viscous fluid.

### Solution to Problem

In consideration of the problem of being incapable of uniformly kneading a highly viscous fluid with the paddle in the three-pronged fork-like shape with the middle part longer than the others based on the conventional technology, the present invention provides a paddle including an arm portion disposed outside the container and a paddle portion integrally formed on a distal end of the arm portion and disposed inside the container, the paddle portion having a horizontal part, vertical parts protruding upward from both end portions of the horizontal part, and a coupling shaft portion protruding upward from a middle of the horizontal part to the arm portion, and at least one of the vertical parts being provided with an inwardly protruding portion at an upper end. This allows the inwardly protruding portion to mix mixing objects in an area corresponding to a non-fluid area, thereby solving the above problem.

### Advantageous Effects of Invention

In summary, the present invention provides a paddle including an arm portion disposed outside the container and a paddle portion integrally formed on a distal end of the arm portion and disposed inside the container, the paddle portion having a horizontal part, vertical parts protruding upward from both end portions of the horizontal part, and a coupling shaft portion protruding upward from a middle of the horizontal part to the arm portion, and at least one of the vertical parts being provided with an inwardly protruding portion at an upper end. This allows the inwardly protruding portion to mix a mixing object in an area corresponding to a non-fluid area with a mixing object in the other area, thereby uniformly mixing the mixing objects in the container.

Because one of the vertical parts is higher than the other vertical part, and the other vertical part is provided with the inwardly protruding portion, a mixing object located above the other vertical part can be mixed by one vertical part, thereby further uniformly mixing the mixing objects in the container.

Because the coupling shaft portion is formed into a columnar portion having a large width and both side portions on which edge portions having a double-edge shape are formed, the mixing object flowing in the container diverges at one edge portion of the coupling shaft portion, flows along the front and back surfaces of the coupling shaft portion, and merges through the other edge portion. Because no groove is generated in a merging part of the mixing object located on the downstream side of the other edge portion, it is possible to prevent mixing of air bubbles into the mixing object.

Because the arm portion and the paddle portion are integrally formed by using a plastic material, it is possible to achieve a reduction in weight and avoid damaging the inner surface of the container without providing any rubber wipers for the lower surface of the horizontal part and the outer side surfaces of the vertical parts.

Because the horizontal part has a lower surface formed as a convex curved surface, the corner portions of the lower portion of the horizontal part have large areas and are directed downward. This makes it possible to fluidize an area of a mixing object in the lower portion of the container, thereby providing significant practical effects such as further improving the mixing performance.

### BRIEF DESCRIPTION OF DRAWINGS

FIG. 1 is a front view of a paddle for a container-rotating mixing device according to the present invention.

FIG. 2 is an enlarged sectional view taken along line X-X in FIG. 1.

FIG. 3 is an enlarged sectional view taken along line Y-Y in FIG. 1.

FIG. 4 is a plan view of a container-rotating mixing device attached with the paddle in FIG. 1.

FIG. 5 is a partially sectional front view of the container-rotating mixing device in FIG. 4.

FIG. 6 is a horizontal sectional view of a container accommodating the paddle in a use situation.

FIG. 7 is a partially sectional front view of a conventional container-rotating mixing device.

### DESCRIPTION OF EMBODIMENTS

A paddle for a container-rotating mixing device according to the present invention includes an arm portion 1 disposed outside a container A and a paddle portion 2 integrally formed with the distal end of the arm portion 1 and disposed in the container A. The paddle portion 2 includes a horizontal part 3, vertical parts 4 and 5 protruding upward from both end portions of the horizontal part 3, and a coupling shaft portion 6 protruding upward from the middle of the horizontal part 3 to the arm portion 1. An inwardly protruding portion 7 is provided on at least one of the upper ends of the vertical parts 4 and 5.

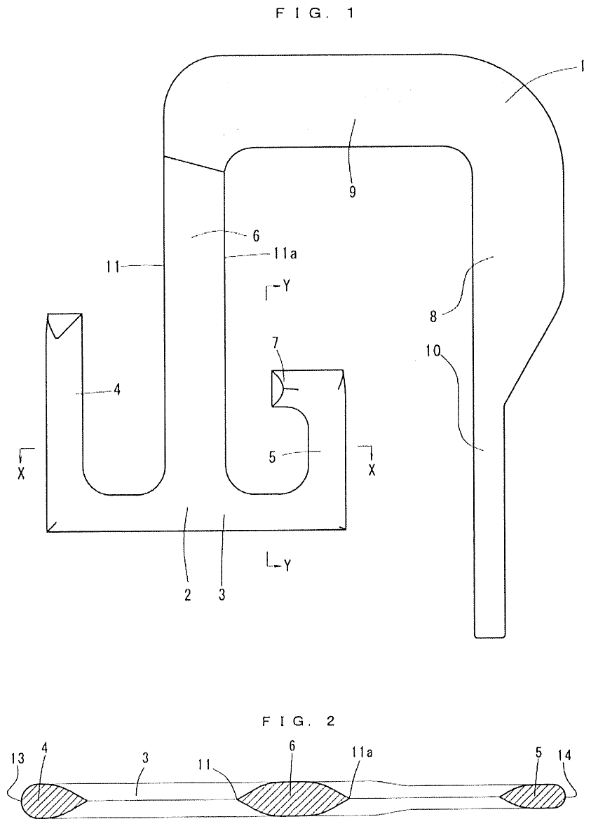

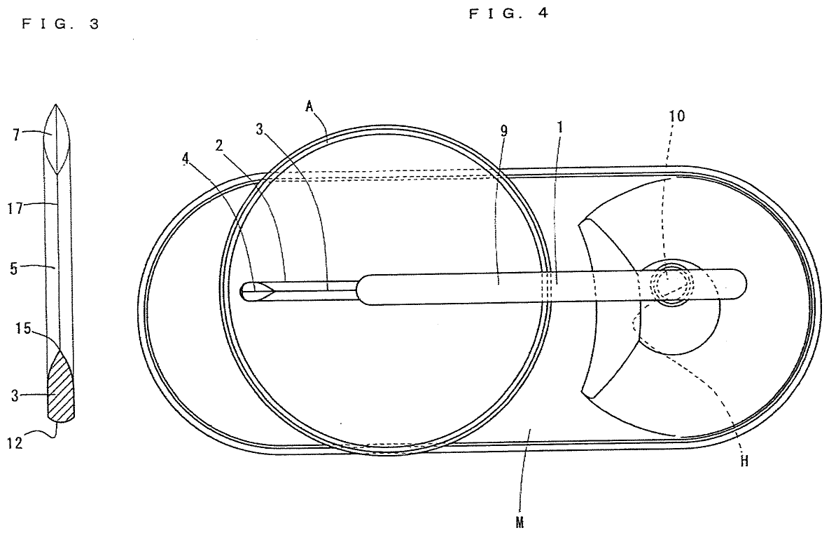

More specifically, this paddle for the container-rotating mixing device is an integrally molded product made of a plastic material, preferably a fiber-reinforced plastic material to which fiber such as glass fiber is added. As shown in FIGS. 1 to 3, the paddle is constituted by the arm portion 1 and the paddle portion 2, and the inwardly protruding portion 7 is formed on the second vertical part 5.

The arm portion 1 has a substantially inverted L shape, with a horizontal part 9 protruding from the upper end of a columnar support part 8 and a lower part of the columnar support part 8 being formed as an insertion portion 10 having a round bar shape.

The paddle portion 2 has the first vertical part 4 higher than the second vertical part 5 and the coupling shaft portion 6 having a large width and formed into a columnar shape with edge portions 11 and 11a being formed on both side portions in a double-edged shape. More specifically, the coupling shaft portion 6 has a columnar shape having a flat hexagonal shape as a horizontal sectional shape, with four corner portions other than the edge portions 11 and 11a being round-chamfered into R-surfaces.

The lower surface of the horizontal part 3 and the outer side surfaces of the vertical parts 4 and 5 are formed as convex curved surfaces 12, 13, and 14, and edge portions, each having a double-edged shape, are formed on the upper surface of the horizontal part 3 and the inside surfaces of the vertical parts 4 and 5. More specifically, each sectional shape has a teardrop shape.

Although the part on the second vertical part 5 side of the horizontal part 3 is thinner than the part on the first vertical part 4 side when viewed in the drawings, the thicknesses of the parts may be the same.

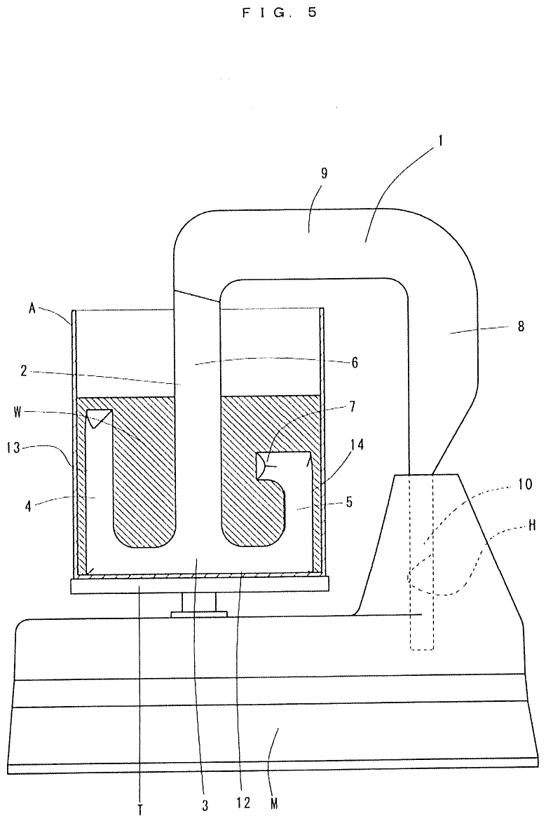

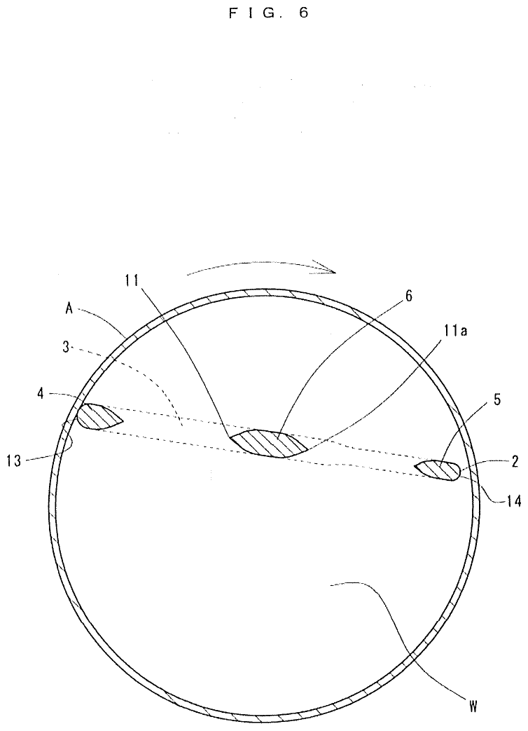

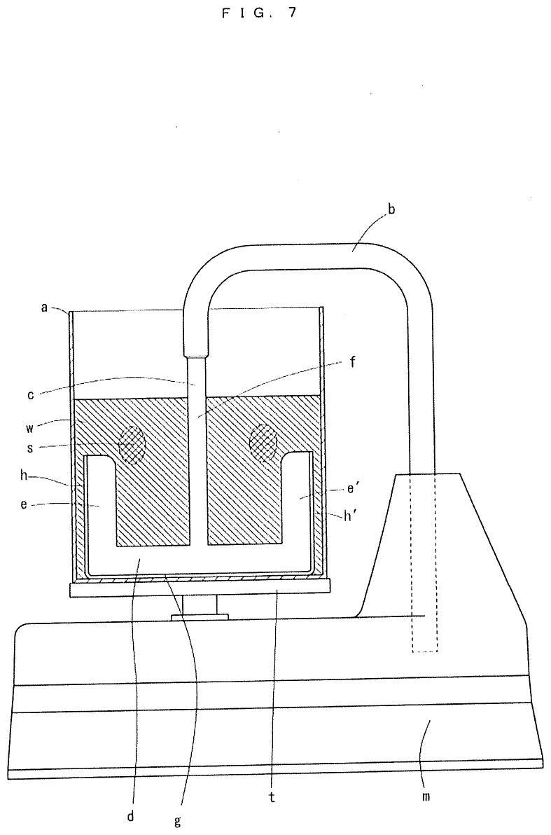

As shown in FIGS. 4 and 5, the insertion portion 10 of the arm portion 1 is inserted into an insertion hole H in the mixing device M, and the paddle portion 2 is accommodated in the container A installed on a turntable T. The container A is then rotated by the turntable T. As shown in FIG. 6, the paddle portion 2 pushed by a mixing object W moves until coming into contact with the container A. The paddle portion 2 then mixes the mixing object W (for example, a sealing material) as a highly viscous fluid in the container A. Because the inwardly protruding portion 7 eliminates any non-fluid area of the mixing object W, the mixing object W is uniformly mixed.

Forming the paddle for the container-rotating mixing device according to the present invention by using a plastic material prevents the container A from being damaged even if the paddle portion 2 strikes the container A. Forming the lower surface of the horizontal part 3 and the outer side surfaces of the vertical parts 4 and 5 as the convex curved surfaces 12, 13, and 14 reduces frictional resistance with respect to the inner surface of the container A.

### EXPERIMENT 1

A conventional paddle having a scraping effect, with the coupling shaft portion being formed into a rectangular plate-like shape was used. The mixing object was a 4 wt % aqueous solution of CVP used as a model plastic fluid. A container-rotating mixing device rotated the container at a speed of 45 rpm, with the interval of forward/backward rotations being 30 sec. Visualizing a mixing process by a decolorization method revealed that a non-fluid area was formed at the center of the container or near the bottom of the container.

### EXPERIMENT 2

A mixing visualization experiment was conducted to check the performance of prototype 1 of a paddle according to the present invention.

The diameter of the container A was set to 120 mm. The blade diameter of prototype 1 was set to 115 mm. The height of the first vertical part 4 and the height of the second vertical part 5 were respectively set to 85 mm and 60 mm. The prototype was installed such that the lower surface of the horizontal part 3 is almost in contact with the bottom of the container.

The mixing object used was starch paste having a larger yield value than CVP aqueous solution. The container-rotating mixing device rotated the container at a speed of 45 rpm, with the interval of forward/backward rotations being 30 sec. The visualization of a mixing process of the prototype and the mixing time were observed and measured by using a decolorization method.

Although a qualitative observation, decolorization was completed in about 600 sec., and a thin film that was not yet decolorized was left on an upper portion of the wall of the container A. This may be because the second vertical part 5 is lower in height than the first vertical part 4, and hence the scraping effect is slightly weakened compared with the conventional paddle.

However, because the conventional paddle took about 900 sec. to complete mixing, the prototype can be regarded as having improved the mixing performance even with the low second vertical part 5.

The prototype can also be regarded as being able to prevent mixing of air bubbles because the prototype can reduce the portion exposed from a liquid surface.

### EXPERIMENT 3

An experiment with an actual liquid was conducted by using prototype 2 of a paddle according to the present invention.

The diameter of the container A was set to 210 mm. Prototype 2 was made of GFRP to prevent breakage. The blade diameter was set to 205 mm so as to bring the paddle into contact with the wall of the container A when the paddle is deformed. The height of the first vertical part 4 and the height of the second vertical part 5 were respectively set to 150 mm and 110 mm. The prototype was installed such that the lower surface of the horizontal part 3 was almost in contact with the bottom of the container A.

The mixing object W that was used was a polyurethane-based sealing material (Hamatite SC-PU2NB available from The Yokohama Rubber Co., Ltd.) with a large yield value used in building sites. Two types of liquids, namely a base component (white) and a curing agent (transparent), were mixed at a ratio by weight of 10:1 into a total amount of 6 L. The container-rotating mixing device rotated the container at a speed of 45 rpm, with the interval of forward/backward rotations being 30 sec. In order to visually observe a mixing process and to measure the mixing time, a black tracer was added to the liquid free surface.

Although a qualitative observation, it was judged that mixing of a polyurethane-based sealing material was completed in about 300 sec.

The white base component and the transparent curing agent were uniformly mixed, and the mixture was cured after one day (not cured if mixing was not sufficient).

When the mixing object W with high apparent viscosity was mixed by using the container-rotating mixing device having a forward/backward inversion mechanism, it was observed that even when the paddle was installed centered on the shaft, the paddle was deflected upon receiving stress from the mixing object W.

It can be regarded that this effect, adding the effect of eccentric agitation (see FIG. 6), made the flow in the container A more unsteady, thereby promoting mixing.

A sealing material is required to prevent mixing of air bubbles to improve quality. Observing a section obtained by verticality sectioning a cured sealing material filled in a can reveals that the section obtained by prototype 2 includes significantly fewer mixed air bubbles than the section obtained by the conventional paddle. It can be regarded that the sealing material can sufficiently prevent mixing of air bubbles.

Accordingly, optimal conditions for a paddle according to the present invention for the elimination of non-fluid areas observed with the conventional paddle include (1) to (6) described below:

(1) The coupling shaft portion 6 is a plate-like shape.

(2) In order to eliminate non-fluid areas in a central portion of the container, the inwardly protruding portion 7 is formed at a position on the second vertical part 5 at which a doughnut ring is generated, thereby forming a left-right asymmetrical shape.

(3) In order to increase the scraping effect, the longitudinal width of the horizontal part 3 and the horizontal widths of the vertical parts 4 and 5 and the coupling shaft portion 6 are increased, the edge portions 11 and 11a are formed on both side surfaces of the coupling shaft portion 6, and edge portions are formed on the inside surfaces of the horizontal part 3 and the vertical parts 4 and 5.

(4) In order to eliminate non-fluid areas at the lower portion of the container A, the lower surface of the horizontal part 3 and the outer side surfaces of vertical parts 4 and 5 are formed as the convex curved surfaces 12, 13, and 14, and the area of the corner portion of the lower portion of the horizontal part 3 is increased.

(5) In order to make an unsteady operation effective for a mixing operation, a container-rotating mixing device having a forward/backward inversion mechanism with an inversion interval of 30 sec. is used.

(6) In order to improve the quality of the mixing object W after mixing, the height of the second vertical part 5 is set to make the distal end lower than a liquid level so as to prevent mixing of air bubbles as much as possible.

### REFERENCE SIGNS LIST

1: arm portion

2: paddle portion

3: horizontal part

4, 5: vertical part

6: coupling shaft portion

7: inwardly protruding portion

11, 11a: edge portion

12: convex curved surface

A: container

1. A paddle for a container-rotating mixing device that mixes a mixing object in a container by rotating the container placed on a turntable, the paddle comprising an arm portion disposed outside the container and a paddle portion integrally formed on a distal end of the arm portion and disposed inside the container, the paddle portion having a horizontal part, vertical parts protruding upward from both end portions of the horizontal part, and a coupling shaft portion protruding upward from a middle of the horizontal part to the arm portion, and at least one of the vertical parts being provided with an inwardly protruding portion at an upper end.

2. The paddle for the container-rotating mixing device according to claim 1, wherein one of the vertical parts is higher than the other vertical part, and the other vertical part is provided with the inwardly protruding portion.

3. The paddle for the container-rotating mixing device according to claim 1, wherein the coupling shaft portion is formed into a columnar portion having a large width and both side portions on which edge portions having a double-edge shape are formed.

4. The paddle for the container-rotating mixing device according to claim 1, wherein the arm portion and the paddle portion are integrally formed by using a plastic material.

5. The paddle for the container-rotating mixing device according to claim 1, wherein the horizontal part has a lower surface formed as a convex curved surface.
